(19) United States
(12) Patent Application Publication
(10) Pub. No.: US 2026/0238843 A1
(43) Pub. Date: Aug. 13, 2026

(54) Method for managing the playback of multimedia content

(71) Applicant: ORANGE, ISSY LES MOULINEAUX (FR)

(72) Inventors: Hervé MARCHAND, Chatillon (FR); Mathieu RIVOALEN, Chatillon (FR)

(21) Appl. No.: 19/153,747

(22) PCT Filed: Jan. 29, 2024
(86) PCT No.: PCT/EP2024/052048

§ 371 Date: Aug. 5, 2025

(30) Foreign Application Priority Data
Feb. 6, 2023 (FR) FR2301073

(51) Int. Cl. H04N 21/262; H04N 21/472

(52) U.S. Cl. CPC H04N 21/26275; H04N 21/47202

(57) ABSTRACT

A method for managing access to a portion of television content that has already been broadcast by a server on a first multicast channel. The method includes: during the broadcasting of the content on the first channel, the server receiving selection data, which represents a selection of a portion of the content that has been broadcast; followed by extracting a portion of the content on the basis of the selection data; and broadcasting the extracted portion on a second multicast channel that is separate from the first channel.

### CROSS-REFERENCE TO RELATED APPLICATIONS

This Application is a Section 371 National Stage Application of International Application No. PCT/EP 2024/052048, filed Jan. 29, 2024, and published as WO 2024/165355 on Aug. 15, 2024, not in English which claims priority to and the benefit of French Patent Application No. FR 2301073, filed Feb. 6, 2023, the contents of which are incorporated herein by reference in their entireties.

### TECHNICAL FIELD

The field of the invention is that of digital multimedia content items, namely digital audio and/or video content items, also called audiovisual content items.

The invention relates most particularly to a method for managing playback of a multimedia content item.

The content items referred to here are content items divided into chunks associated with several respective encoding rates which may be selected on requests sent from a multimedia stream playback device.

A playback device refers to all devices which are able to receive multimedia streams, for example a set-top box, a mobile telephone, a tablet etc.

The content item referred to here is a content item having a scheduled broadcast time. Such a content item is, for example, a “live” content item broadcast by a television channel.

### PRIOR ART

It sometimes happens that the start of a television program (movie, series etc.) is missed. A function called “play back from the start” or “catch-up” (also called “start over” or “restart” by a person skilled in the art) makes it possible to replay the content from its start. For example, if a movie begins at 20:50 on a broadcast channel (a television channel) and a user accesses this television channel at 21:17, they may use the start over function in order to be able to play back the content from its start.

Generally, live content broadcasting is based on multicast broadcast technology (also called “multipoint” broadcasting or “group broadcasting” by a person skilled in the art). This technology makes it possible to save an enormous amount of bandwidth in the network of an operator managing the broadcasting, since the content is replicated as close as possible to the playback devices.

On the other hand, when a playback device requests a return in the content so as to receive again chunks which have already been rendered, access to the requested content item triggers an automatic switch from multicast technology to point-to-point (unicast) content broadcast technology. The bandwidth consumption in the network of the operator therefore increases considerably because of the point-to-point transmission between the content server and all of the playback devices which have requested use of the start over function; for example, when the requested content item is a content item with a large audience, the number of point-to-point connections may become enormous and lead to a phenomenon referred to as a bandwidth bottleneck phenomenon, which harms the performance of the network.

### SUMMARY

The invention offers a solution which does not have the drawbacks of the prior art.

To this end, according to a first functional aspect, one subject of the invention is a method for managing access to a portion of a television content item which has already been broadcast by a server on a first multicast broadcast channel, characterized in that it comprises, during the broadcasting of the content item on the first channel, a step of the server receiving a datum, referred to as a selection datum, which is representative of a selection of a portion of the content item which has been broadcast, followed by a step of extracting a portion of the content item on the basis of the selection datum, and a step of broadcasting said extracted portion on a second multicast broadcast channel which is distinct from the first channel.

According to the invention, when a multicast broadcast is in progress on a first broadcast channel for a television content item, one or more other multicast broadcast channels, referred to as second channels, are created and used to broadcast, in multicast mode, portions (or extracts) of this same television content item in parallel with the broadcasting of the content on the first channel.

When a request is made to play back a portion of the content item broadcast on a second broadcast channel, for example a particular scene of the content item if the latter is a motion picture, a management module will select a second channel from a set of available second broadcast channels.

On the one hand, the invention offers simple access to a replay of a content extract. On the other hand, the use of multicast mode instead of unicast mode for the second channel offers optimal rendering quality and considerably reduces the bandwidth on the network during access to a television content item in start over mode. The invention thus makes it possible to create several second multicast broadcast channels relating to extracts of the content item without congesting the bandwidth on the telecommunication network. The invention thus offers for selection one or even more multicast streams which are representative of already broadcast extracts of the content item being broadcast on the first multicast broadcast channel.

Thus, according to the invention, a channel is created on the basis of a selection of an extract made on the playback device. This mode makes it possible for a user of the playback device to select the extract themselves, for example by supplying the start and end instants of the extract as will be described below in one embodiment. Having the possibility of selecting the extract, a user is therefore certain to be able to play back off-line any portion of the content item which has been broadcast.

According to a first embodiment, the broadcasting on the second channel is carried out at the same time as the broadcasting of the content item on the first channel. This first embodiment makes it possible not to cut off the session on the first channel, otherwise a return to the first channel would imply a channel reopening, which takes a certain time, which would be detrimental to the user experience. According to a variant of the first embodiment, the broadcasting of the content item on the first channel ceases when the broadcasting on the second channel starts. This variant has the advantage of a gain in bandwidth on the network which separates the server which broadcasts the content item and the playback device.

According to a second embodiment, which may be implemented as an alternative or in addition to the previous embodiment, the broadcasting on the second channel is carried out in a loop. This second embodiment makes it possible to rewatch a scene at any moment.

Loop broadcasting has corresponding broadcast instants. According to a variant of the second embodiment, the instants for broadcasting on the second broadcast channel are spaced apart by a given duration. This variant makes it possible to gain in bandwidth on the telecommunications network between each broadcast on the second channel.

According to a third embodiment, which may be implemented as an alternative or in addition to the preceding embodiments, the loop broadcasting ceases when the broadcasting of the content item has ended on the first channel. This second embodiment makes it possible to recover channels which are available for catching up on other television content items. According to a variant of this third embodiment, when the broadcasting ceases on the first channel, the broadcasting on the second channel continues until the end of the broadcasting of the extract and then ceases.

According to a fourth embodiment, which may be implemented as an alternative or in addition to the preceding embodiments, after the playback of the content portion on the second channel, the playback of the content item continues via the first channel. This embodiment is advantageous in that no manipulation is necessary on the playback device STB in order to continue playback of the content via the first channel. The absence of manipulation improves the user experience; in addition, playback resumes without delay.

According to a fifth embodiment, which may be implemented as an alternative or in addition to the preceding embodiments, the second broadcasting channel is deleted when the rendering of the content item has ended on the first channel. This embodiment makes it possible to release and therefore recover a second channel for the broadcasting of another content item. This embodiment is notably advantageous when the number of channels is limited in number.

According to a sixth embodiment, which may be implemented as an alternative or in addition to the preceding embodiments, after the playback on the second channel, the playback of the content item continues via the first channel. This embodiment makes it possible to return to the live stream, for example a live soccer match broadcast, as soon as playback on the second channel has ended; the end of playback may be triggered automatically at the end of the content item broadcast on this second channel, or may originate from an explicit request to stop playback coming, for example, from a remote control.

According to a seventh embodiment, which may be implemented as an alternative or in addition to the preceding ones, a selection datum comprises a datum which is able to locate a content extract.

According to a first hardware aspect, the invention relates to an entity for managing access to a portion of a television content item which has already been broadcast by a server on a first multicast broadcast channel, characterized in that it comprises a processor configured to, during the broadcasting of the content item on the first channel, receive a datum which is representative of a selection of a portion of the content item which has been broadcast, an extraction of a portion of the content item on the basis of the datum which is representative of a selection, and a broadcasting of said extracted content portion on a second multicast broadcast channel which is distinct from the first channel.

According to another hardware aspect, the invention relates to a server comprising a management entity as defined above.

According to another hardware aspect, the invention relates to a computer program which is able to be implemented on a management entity as defined above, the program comprising code instructions which, when it is executed by a processor, perform the steps of the method which are defined in connection with the second functional aspect.

According to another hardware aspect, the invention relates to a first data medium on which at least one series of program code instructions for executing a management method as defined in connection with the first functional aspect has been stored.

According to another hardware aspect, the invention relates to a first data medium on which at least one series of program code instructions for executing a management method as defined in connection with the second functional aspect has been stored.

According to a second functional aspect, the invention relates to a method for managing access, by a playback device, to a portion of a television content item which has already been broadcast on a first multicast broadcast channel, characterized in that it comprises, during the broadcasting of the content item on the first channel, a step of receiving a selection of a portion of the content item which has been broadcast followed by a step of sending an access request including a datum, referred to as a selection datum, which is representative of a selection of the selected content portion and a step of receiving the content portion via a second multicast broadcast channel which is distinct from the first channel.

According to another hardware aspect, the invention relates to an entity, referred to as the first management entity, for managing access to a portion of a television content item which has already been broadcast on a first multicast broadcast channel, characterized in that it comprises a processor configured to perform the following steps, during the broadcasting of the content item on the first channel, receiving a selection of a portion of the content item which has been broadcast followed by sending an access request including a datum, referred to as a selection datum, which is representative of a selection of the selected content portion and receiving the content portion via a second multicast broadcast channel which is distinct from the first channel.

According to another hardware aspect, the invention relates to a playback device comprising the first management entity defined above.

According to another hardware aspect, the invention relates to a computer program which is able to be implemented on the first management entity defined above, the program comprising code instructions which, when it is executed by a processor, perform the steps of the management method which is executed by the first entity.

It will be recalled that such a storage medium may be any entity or device which is capable of storing the program. For example, the medium may comprise a storage means, such as a ROM, for example a CD-ROM or a microelectronic circuit ROM, or even a magnetic storage means, for example a USB key or a hard disk. On the other hand, such a storage medium may be a transmissible medium such as an electrical or optical signal, which may be routed via an electrical or optical cable, by radio or by other means, such that the computer program which it contains may be executed remotely. The program according to the invention may, in particular, be downloaded from a network, for example the Internet. As an alternative, the storage medium may be an integrated circuit into which the program is incorporated, the circuit being adapted to execute or to be used in the execution of the aforementioned display control method.

### BRIEF DESCRIPTION OF THE DRAWINGS

The invention will be better understood on reading the following description, which is given by way of example and with reference to the appended drawings, in which:

FIG. 1 depicts a computer system on which one example of an embodiment of the invention is illustrated;

FIG. 2 is a simplified block diagram of the hardware structure of the playback device;

FIG. 3 is a simplified block diagram of the hardware structure of the server;

FIG. 4 illustrates several broadcast channels for the same content item with distinct broadcast instants which are spread over time;

FIG. 5 illustrates one embodiment of the method of the invention in which a single second channel is created.

### DETAILED DESCRIPTION OF ONE EXAMPLE OF AN EMBODIMENT ILLUSTRATING THE INVENTION

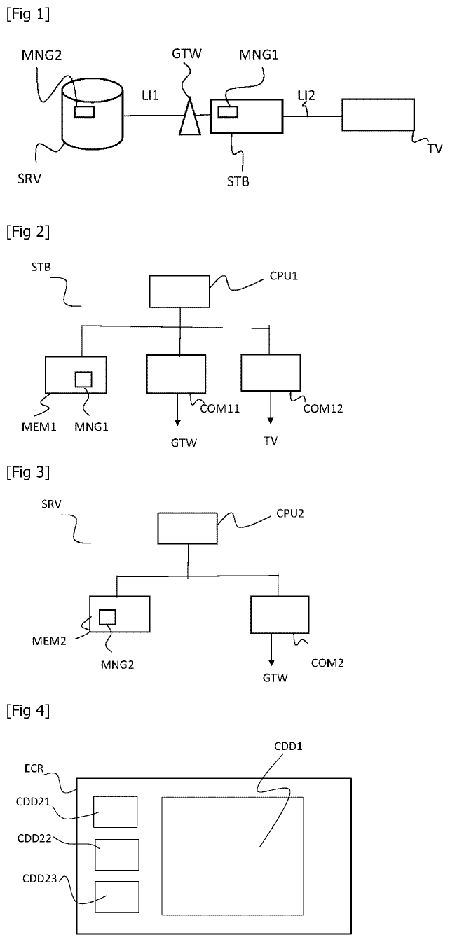

FIG. 1 depicts a computer system SYS in which a content distribution network (CDN) is implemented, from which content items are transmitted to client devices or content playback devices.

In the present example, the system comprises a single playback device STB. However, the invention applies to any number of playback devices.

The playback device STB is, for example, a set-top box.

The multimedia content item referred to here is a video content item corresponding to a television channel on which television programs having a start time corresponding to a scheduled broadcast time and an end time are broadcast.

In the present example, a “play back from the start” function is provided to watch a content item from its start when it has already started or to rewatch an extract of the content item.

In the present example, the set-top box STB is connected to a rendering terminal TV such as a television equipped with a screen.

In the present example, the playback device STB is connected to a port of the rendering device TV; the playback device and the rendering device TV could also form one and the same device.

In the present example, the playback device STB is located in a local area network LAN managed by a residential gateway GTW. The context of the local area network is given by way of example and could easily be transposed to a “best-effort” Internet network, a company network etc.

The gateway GTW is able to communicate via a telecommunication network LI1, such as a wide area network WAN known to a person skilled in the art.

The CDN consists of servers which are networked in the wide area network; these servers SRV cooperate in order to make multimedia content items available to users. In order to simplify the disclosure of the invention, a single content server SRV will be depicted in FIG. 1 to depict the CDN.

The content server SRV is located, in the present example, in the wide area network WAN. The content server SRV receives, for example, channels of digital-television content items originating from a television broadcast network (not depicted) and makes them available to client terminals, here the playback device STB.

The content items CNT are made available in a given format. Such a content item CNT is, for example, a content item downloaded in adaptive streaming mode. The MPEG-DASH (dynamic adaptive streaming over HTTP) standard is a format standard for audiovisual broadcasting over the Internet; this standard is based on preparing the content item in various representations of variable quality and bit rate, divided into chunks of short duration (of the order of a few seconds). Each of these chunks is made available individually by means of a protocol for exchange between the rendering terminal and the server providing multimedia content items. The protocol mainly targeted is the HTTP protocol, but other protocols (for example FTP) may also be used. The organization of the chunks and the associated parameters are published in a manifest in XML format. More detail of this downloading mode will not be gone into because it is of no interest to the disclosure of the invention.

FIG. 2 depicts an architecture of a playback device STB. This playback device STB conventionally comprises memories MEM1 associated with a processor CPU1. The memories may be ROMs (read-only memories) or RAMs (random access memories), flash memories or any other equivalent memories.

The playback device STB may transmit a content item to be rendered to the rendering device TV via a communication module COM12. This module COM12 is, for example, an HDMI link.

The playback device STB communicates with the gateway GTW via an Ethernet module for wired local communication or via a Wi-Fi radio module for wireless local communication. The module in question is referenced COM11 in FIG. 2.

The playback device STB comprises a streaming-mode download entity (not depicted) which is able to manage the downloading of chunks.

With reference to FIG. 3, the server SRV is also equipped with at least one processor CPU2 and with memories MEM2 for performing electronic data processing. The server is also equipped with a management entity MNG2, which is one subject of the invention and is able to manage the transmission of a content item from the server SRV to one or more playback devices. The server SRV communicates with the gateway GTW via a network WAN in order to communicate with the home gateway GTW. The module in question is referenced COM2 in FIG. 3.

Several multicast broadcast channels are created for broadcasting several content items respectively.

It is assumed that a content item is broadcast in multicast mode. Each playback device STB which requests it may receive and play back such a content item.

It will be specified here that creating a channel may consist in instantiating a channel. It will also be recalled here that the created broadcast channels are declared in a document called a live service plan. These declarations are then visible on a human-machine interface and may be selected from a control device with a view to rendering. It will be recalled that the service plan groups together all accessible television channels and other content items, such as video-on-demand content items or the like.

It is now assumed that a content item CNT is broadcast on a first broadcast channel CDD1. The aim of the invention is to replay a portion of this content item which has already been broadcast.

According to the invention, considering a television content item CNT in particular, during the broadcasting of the content item on the first channel, a selection of an extract of the content item is received by the first management entity MNG1. The selection in question may be made via a human-machine interface.

Then the entity MNG1 transmits to the server SRV a request including a datum, referred to as a selection datum, which is representative of the selection of content. It will be seen below that the selection datum refers to a datum, or a set of data, which makes it possible for the entity MNG2 which is present on the server SRV to extract a content portion. It will therefore be understood that the selection is carried out outside the server, and that it is therefore not the content broadcaster which determines the portion of the content item to be extracted.

Then the entity MNG2 receives the selection datum coming from the playback device STB and extracts the portion of the content item on the basis of the selection datum; finally, the entity MNG2 broadcasts the extracted portion on a second multicast broadcast channel which is distinct from the first channel.

More generally, during the broadcasting of the content item via the first broadcast channel, the entity MNG2 may receive, from the playback device STB, several requests including respective selection data, and create, in response to these requests, one or even several other multicast broadcast channels referenced CDD21-CDD23, referred to as second broadcast channels, for rebroadcasting portions of the television content items (or extracts) which have already been broadcast. In other words, the first channel CDD1 is used to broadcast the content item CNT and the second channels CDD21-CDD23 are used to broadcast portions of the content item (or extracts from the content item), respectively. Preferably, the extract EXT is selected on the playback device STB. As an alternative or in addition, the extract may also be chosen judiciously by the second entity; the extract will be, for example, a scene which will interest a large number of users of playback devices STB. The extract may, for example, be a goal of a soccer match.

FIG. 4 illustrates a way of accessing one of the streams coming from the channels CDD1 and CDD21-CDD23 which are associated with the same content item. This FIG. 4 depicts a human-machine channel selection interface rendered on the screen of the television TV. In the present example, this selection interface includes the content item associated with the first channel CDD1, which occupies a larger space on the screen in the present example so as to continue playing back the content item while at the same time displaying the content portions CDD21-CDD23 which are accessible via the second channels respectively. The latter are also visible on the screen and selectable.

The invention is not limited to the embodiment described in this FIG. 4; other ways of depicting the various channels relating to the same content item on the selection interface are obviously conceivable.

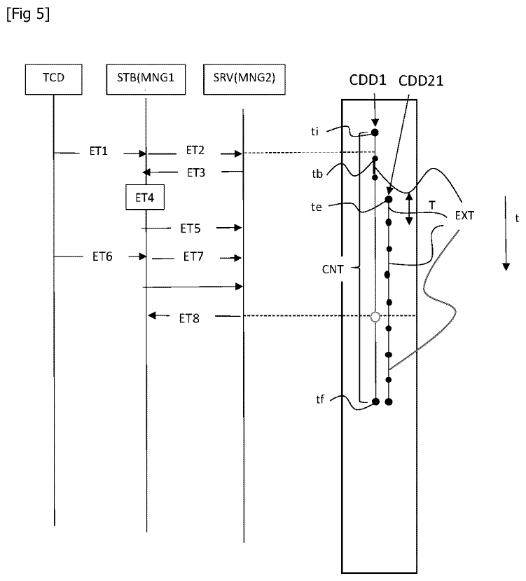

According to the invention, a selection of a portion of content associated with a second channel, via the interface, will trigger, as will be seen with reference to FIG. 5, control of access, by the set-top box, to the stream broadcast on the selected second multicast broadcast channel. After selection, the playback device STB receives the stream broadcast on the second channel and the extract of the content item concerned is rendered on the screen.

In the example of an embodiment described below, in order to simplify the disclosure of the invention, a single second broadcast channel CDD21 will be used to illustrate the invention. By extension, the principle described below will apply to any number of second broadcast channels.

A soccer match the official broadcast of which is scheduled on a Saturday evening at 20:00(ti=20:00) and the end of which is predicted at 21:45(tf=21:45) will be taken as an example.

The method comprises several steps referenced ETk (k is an integer).

During a step ET1, a command SEL to select a content item CNT is transmitted from the remote control to the playback device STB.

During a step ET2, the playback device STB receives the command and executes it; the execution of the command leads to a transmission of a request for access to the content item CNT to the server SRV.

During a step ET3, after transmission of a manifest associated with the content, the server SRV successively transmits chunks of the content item CNT to the playback device STB; the playback device STB then receives the chunks of the content item from the first channel CDD1 and requests a rendering of the chunks on the television TV.

It will be supposed that during the soccer match a goal is scored at 20:30 at the instant tb.

Following the goal, during a step ET4, the entity MNG2 which is present on the server SRV receives a request to create a second channel CDD21. The creation request may be of any origin. The request may, for example, originate from a command coming from a control device. For example, a user of the control device presses on a key of the remote control in order to send a command which is able to request the creation of a second channel from the entity MNG2. The user may supply the start instant tb and possibly an end instant of the extract EXT in question. In the present example, with reference to FIG. 5, the extract has a duration T.

The request to create the second channel CDD21 may also originate from a computer program which is capable of detecting an event in a video, such as a goal, and of automatically transmitting a channel creation command to the entity MNG2.

Following the receipt of the channel creation request, during a step ET5, the entity MNG1 requests the transmission, to the server SRV, of a request to create a second channel CDD21 for broadcasting the extract EXT.

In the present example, the request includes data, referred to as selection data, which are representative of the extract selected on the playback device STB. These selection data refer to data which are sufficient for the server to recognize the content portion to be extracted from the content item which has been broadcast. These data are, for example, the start and end instants described above; or else a start instant and a duration, or even a description of a scene etc. The description of a scene is, for example, in the context of a soccer match, words such as “goal” or “action” etc.

At this stage, the server SRV, meaning the entity MNG2, requests the creation of a second channel CDD21 on the basis of the received selection data, for example on the basis of the start and end instants of the extract, and broadcasts, in multicast mode, the extract in question on this second channel CDD21. The broadcasting on the first channel CDD1 and the second channel CDD21 is carried out in parallel.

The broadcasting on the second channel CDD21 may be carried out in a loop for a given duration. Since a soccer match comprises a half-time which lasts fifteen minutes, a user wishing to rewatch the action may, for example, access the extract during this half-time. According to a variant, the loop broadcast may be carried out over predefined time ranges such as half-time, advertisements etc.

The broadcasting on the second channel CDD21 may be performed in a loop throughout the duration of broadcasting on the first channel CDD1 so as to access the extract throughout the playback of the content item.

In FIG. 5, the extract of a duration T is broadcast in a loop without a pause between the instant of the end of the broadcasting of the extract and the instant of the start of the broadcasting of the same extract which follows. In FIG. 5, the extract EXT is broadcast eight times, each extract having a duration T.

According to a variant (not depicted in the figures), a delay is implemented between each instant of the broadcasting of the extract on the second channel CDD21. In other words, when the playback of the extract reaches its end, a waiting delay is implemented before the replay of the extract on the channel CDD21.

It is now assumed that a user wishes to access the extract broadcast on the second channel CDD21.

During a step ET6, the playback device STB receives a command to read the extract coming from the control device TCD.

During a step ET7, the playback device STB transmits, to the server SRV, a command to read the extract EXT broadcast on the second channel CDD21.

During a step ET8, the server SRV transmits chunks of the extract EXT via the second channel CDD21.

During a subsequent step, the playback device STB decodes the segments and renders the extract EXT.

In the present example, when the broadcasting of the content item CNT on the first channel ends at the instant tf, the broadcasting of the extract on the second channel also ceases. Returning to the example above, when the soccer match ends, the broadcasting of the clips also ceases.

According to a variant, when the broadcasting of the content item CNT on the first channel ends at the instant tf, the broadcasting of the extract on the second channel continues and ceases at the end of the playback of the extract.

As indicated above, the second channel CDD21 is created following the receipt of a datum which is representative of a selection of an extract, meaning following a request to playback via a second channel. For example, a user indicates from what instant they wish to replay a content portion; upon receipt, the entity MNG1 transmits the instant in question to the entity MNG2. The entity MNG2 receives the instant and then creates a second channel CDD21 from this start instant.

It will be understood that the creation of this second channel CDD21 will benefit other playback devices STB which wish to access the same extract via the channel CDD21 created to this end.

The second channel CDD21 may be created at the explicit request of a playback device STB. This avoids creating a second channel relating to an extract which does not interest anyone.

It should be noted that the created second channels CDD21-CDD23 may have a limited or unlimited lifetime. According to one embodiment, the second broadcast channel CDD21 is deleted when the rendering of the content item on the first channel CDD1 has ended. The deleted second channel may then be assigned to another entity, for example another television channel.

According to a variant, following the playback of the extract EXT on the second channel CDD21, the playback of the content item CNT continues automatically via the first channel CDD1. This variant avoids manipulation on the part of a user when the playback of the extract has ended and they wish to continue playing back the content item on the first channel CDD1.

It will be understood above that, when access to the extract EXT is requested, the latter may already be being broadcast on the second channel; this implies that the extract is not always played back from the start of the extract EXT. In order to play back the extract from its start, the instant of playback by the playback device STB may be carried out in several ways:

According to a first way, the extract EXT is played back without waiting. The risk in this case is that the extract is already being rendered; the rendering on a screen is therefore not carried out wholly but in part because the start of the extract has already been broadcast. If the user wishes to watch the extract from the start, and because of the loop playback, the extract will be accessible from its start during the replay.

According to a second way, if the extract is being played back, the entity MNG1 requires a suspension of the playback of the stream received via the second channel CDD21 until the playback resumes from the start. In this way, the extract EXT which the playback device STB receives is complete. The user experience can only be better. During the suspension referred to above, the playback of the content item on the first channel CDD1 may be continued.

It will finally be specified here that the term module or the term entity may correspond equally to a software component or to a hardware component or to a set of hardware and software components, a software component itself corresponding to one or more computer programs or subroutines or, more generally, to any element of a program which is able to implement a function or a set of functions as described for the modules concerned. In the same way, a hardware component corresponds to any element of a hardware assembly which is able to implement a function or a set of functions for the module in question (integrated circuit, chip card, memory card etc.).

Although the present disclosure has been described with reference to one or more examples, workers skilled in the art will recognize that changes may be made in form and detail without departing from the scope of the disclosure and/or the appended claims.

1. A management method implemented by a management device and comprising:
managing access to a portion of a television content item which has already been broadcast by a server on a first multicast broadcast channel, wherein the managing comprises, during the broadcasting of the content item on the first channel:
the server receiving a selection datum which is representative of a selection of a portion of the content item which has been broadcast, followed by:
extracting a portion of the content item on the basis of the selection datum; and
broadcasting the extracted portion on a second multicast broadcast channel which is distinct from the first channel.

2. The management method as claimed in claim 1, wherein the broadcasting on the second channel is carried out in a loop.

3. The management method as claimed in claim 2, wherein the instants for broadcasting on the second broadcast channel are spaced apart by a given duration.

4. The management method as claimed in claim 2, wherein the loop broadcasting ceases when the broadcasting of the content item has ended on the first channel.

5. The management method as claimed in claim 1, wherein the second broadcast channel is deleted when the rendering of the content item has ended on the first channel.

6. The management method as claimed in claim 1, wherein, after playback of the content portion on the second channel, the playback of the content item continues via the first channel.

7. The management method as claimed in claim 1, wherein the selection datum comprises a datum which is able to locate a content extract.

8. A management device comprising:
at least one processor; and
at least one non-transitory computer readable medium comprising instructions stored thereon which when executed by the at least one processor configure the management device to manage access to a portion of a television content item which has already been broadcast by a server on a first multicast broadcast channel, wherein the managing comprises:
during the broadcasting of the content item on the first channel, receiving a datum which is representative of a selection of a portion of the content item which has been broadcast;
extracting a portion of the content item on the basis of the datum which is representative of the selection; and
broadcasting said portion on a second multicast broadcast channel which is distinct from the first channel.

9. A non-transitory computer readable medium comprising a computer program stored thereon comprising code instructions which, when executed by a processor of the management device, perform the management method defined in claim 1.

10. A server comprising the management device as defined in claim 8.

11. (canceled)

12. A method implemented by a playback device and comprising:
managing access, by a playback device, to a portion of a television content item which has already been broadcast on a first multicast broadcast channel, wherein the managing comprises:
during the broadcasting of the content item on the first channel, receiving a selection of a portion of the content item which has been broadcast, followed by:
sending an access request including a selection datum which is representative of the selection of the selected content portion; and
receiving the content portion via a second multicast broadcast channel which is distinct from the first channel.

13. A management device comprising:
at least one processor; and
at least one non-transitory computer readable medium comprising instructions stored thereon which when executed by the at least one processor configure the management device to manage access to a portion of a television content item which has already been broadcast on a first multicast broadcast channel, wherein the managing comprises:
during the broadcasting of the content item on the first channel, receiving a selection of a portion of the content item which has been broadcast followed by sending an access request including a selection datum, which is representative of the selection of the selected content portion and receiving the content portion via a second multicast broadcast channel which is distinct from the first channel.

14. A playback device comprising the management device as defined in claim 13.

15. A non-transitory computer readable medium comprising a computer program stored thereon comprising code instructions which, when executed by a processor of the management device, perform the method defined in claim 12.

16. The management method as claimed in claim 1, wherein the management device is implemented in the server.
